(19) United States
(12) Patent Application Publication
(10) Pub. No.: US 2005/0016668 A1
(43) Pub. Date: Jan. 27, 2005

(54) Method and apparatus for cutting through an outer layer on a container

(75) Inventors: Lori Powers, Los Angeles, CA (US); Conrad O. Diaz, Canoga Park, CA (US)

Correspondence Address: Robert M. Ashen, Esq.;Law Offices of Robert A. Seldon, 18th Floor, 10940 Wilshire Boulevard, Los Angeles, CA, 90024, US

(73) Assignee: LORI POWERS

(21) Appl. No.: 10/868,691

(22) Filed: Jun. 15, 2004

Related U.S. Application Data
(60) Provisional application No. 60/478,178, filed on Jun. 16, 2003.

(51) Int. Cl. B32B 31/00; B26D 1/00

(52) U.S. Cl. 156/250; 83/13; 156/510; 83/72

(57) ABSTRACT

Apparatus for cutting an outer layer on a container such as a CD case. In one form this apparatus includes a frame or housing with guides defining a path for the container to move along. A cutting blade is mounted on the frame at a fixed location along the path, and extending into the path so as to cut the container outer layer as the container moves along the path. In another form, the container is held in a fixed location and a blade is moved relative to the container to cut the outer layer. A retracting safety mechanism may be provided to retract the blade when it is not cutting to shield it from the user. The mechanism may be operated manually or automatically by the movement of the container relative to the blade. One form of the apparatus is particularly adapted to cut the manufacturer's sealing label on cases for CDs, DVDs, etc.

This application claims priority of prior U.S. provisional application Ser. No. 60/478,178, filed Jun. 16, 2003.

### FIELD OF INVENTION

Cutting through an outer wrapping or layer on a container or package, particularly a manufacturer's sealing label on containers or cases for CDs, DVDs and the like.

### BACKGROUND OF THE INVENTION

There are a great many different devices available for cutting through wrappings on containers. Many are simply handheld cutters in various forms. Such devices have exposed blades which can present a risk particularly to children. They also tend to be difficult to operate since there is not a fixed relationship established and maintained between the cutter and the container to be cut while the user and attempts to accomplish the desired cutting operation. Others are very complex, sophisticated and costly devices to perform repetitive operations on a large number of containers so as to justify the large cost.

Applicants are not aware of simple and economical cutting devices which securely hold the container to be cut during the cutting operation, and particularly such a device that maintains the cutter in a safe shielded position to minimize the chance for the user to cut themselves while using the device. It is also important that such a device the easy to use. This is especially important for a device designed to open CDs and DVD containers since the users will often be younger people who may be less careful and anxious to open the containers and use the CD and DVDs.

With particular regard to containers for CDs and DVDs there is a particular need to deal with the manufacturer's sealing label now almost universally used on such containers. To prevent easy opening of the container and unlawful removal of the CD or DVD, such labels are made very tough and difficult to casually break or cut through. This presents a problem for the purchaser after having purchased the product.

FIG. 17 schematically illustrates a CD container in a partially opened condition. It will be noted that the covers section C has an overhanging upper lip L. The main section M has a thin upstanding rib R that aligns with the lip L when the container is closed, as shown in FIG. 18. The manufacturer's sealing label ML has a portion adhered to the lip L while the remainder of the label extends over the top of the rib R on the main section M and continues around the main section. There are currently available cutting devices which generally attempt to cut across the top of the closed container about midway between its front cover face and its rear main section face. After such a cut, a major portion of the label remains adhered to the cover lip L. If the user and then tries to open the container she will not be able to readily do so, or in doing so she will likely break the container cover.

### SUMMARY OF THE DISCLOSURE

A number of different presently preferred embodiments of the invention are disclosed herein. They tend to fall into two groups: in one group the cutter is held at a fixed location (although it may be retractable) and the container is moved relative to the cutter to achieve the cutting. In the other group, the container is held in a fixed position and the cutter is movable relative to the container to accomplish the desired cutting.

Several of the embodiments incorporate a safety feature whereby the cutting blade is normally retracted so that it is at least partially shielded from the user. The blade may be extended to a cutting position where it is not shielded when required to perform the cut on the container. Such extension and retraction of the blade is sometimes manually accomplished, and is sometimes automatically accomplished incident to the relative movement between the container and the blade.

One presently preferred embodiment of the invention is particularly directed to problems associated with opening containers for CDs and DVDs as discussed above, particularly the cutting and removal of the manufacturer's sealing label ML. Using that apparatus, a cut is made across the top of the CD container close enough to the separation line S-S between the rib R of the main section M and the lip L of the cover section C so that the container can be readily opened after the cut has been made without risk of damage to the container. On the other hand, the cut is far enough away from the line of separation S-S so that, after the cover C has been opened, there will be an adequate portion P of the label extending from the rib R to allow the user to grasp that portion to remove it from the rib. The approximate position of the cut made by this apparatus is indicated in FIG. 18 as line X-X. The cut is desirably a short distance from the line of separation S-S, generally in the range of about 0.050 of an inch to about 0.14 of an inch. FIG. 19 illustrates the container after the cut has been made and the cover has been opened: the portion P of the label ML that has been separated from the lip L is extending outwardly from the rib R so that it can be grasp by the user and pulled free from the container. It will be appreciated that the cutter 30 operates two cut through both the manufacturer's sealing label ML and the thin plastic outer film or layer 28. As used herein “outer layer” refers to both the label and the film.

### IN THE DRAWINGS

FIG. 1 is a perspective view of a cutting apparatus that is a presently preferred embodiment of the invention, and of a CD container to be cut by the apparatus.

FIG. 2 is an enlarged partial side view, with portions broken away to reveal interior details of construction, of the apparatus of FIG. 1, illustrating the ready mode of the apparatus.

FIGS. 3 through 8 are partial side views of the apparatus of FIG. 1, illustrating the progressive operation of the apparatus as the CD container is first inserted into the apparatus and then remove from the apparatus.

FIG. 9 is a schematic side view of the latch of the apparatus of FIG. 1.

FIG. 10 is a schematic side perspective view of another form of cutting apparatus that is another presently preferred embodiment of the invention, utilizing a movable location cutting blade.

FIG. 11 is a schematic end sectional view of the apparatus of FIG. 10.

FIG. 12 is schematic top view of the apparatus of FIG. 10.

FIG. 13 is a side view of another form of cutting apparatus that is another presently preferred embodiment of the invention, utilizing a movable location cutting blade.

FIG. 14 is a top view of the cutting apparatus of FIG. 13.

FIG. 15 years a schematic side view, with portions broken away, of another form of cutting apparatus which is another presently preferred form embodiment of the invention, utilizing a fixed location cutting blade.

FIG. 16 is a schematic side sectional view of the apparatus of FIG. 15.

FIG. 17 is a schematic perspective view of a CD container shown in an opened condition.

FIG. 18 is an enlarged top plan view of the CD container shown in a closed position.

FIG. 19 is a top plan view of the container shown with the manufacturer's label cut, and the cover opened.

### DETAILED DESCRIPTION OF THE DRAWINGS

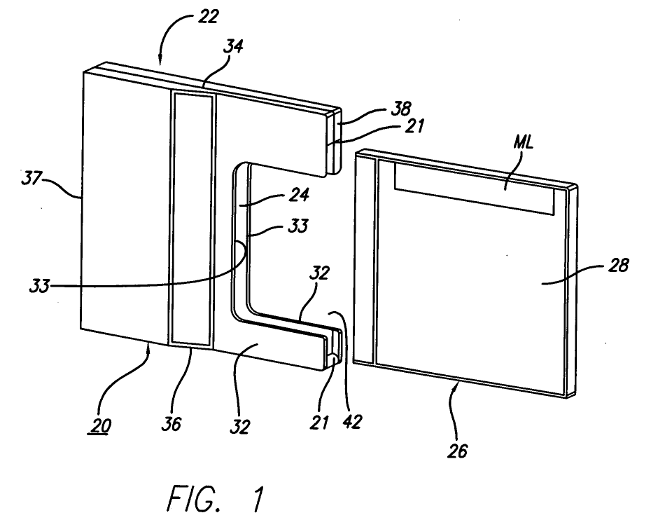

FIGS. 1 through 9 illustrate a cutting apparatus that is a presently preferred embodiment of the invention.

In general, the illustrated cutting apparatus 20 includes a housing or frame 22 that has guides 21 for supporting and guiding a CD container 26 along a predetermined path as the container is inserted and then removed from the frame. The insertion and removal of the container serves to cut through a thin plastic wrapping layer 28 and a manufacturer's sealing label ML on the container. After the cut the layer 28 and the label ML may then be readily removed from the container.

More particularly, the illustrated frame 22 is in the form of an enclosed housing that provides an internal receptacle 24 along the path for receiving the container. The illustrated housing 22 houses a retractable cutting blade 30 at a fixed location along the path. The illustrated blade 30 is automatically actuated by the insertion and removal of the container: the blade 30 is moved to a cutting position extending into the container path while the container is within the receptacle 24, but it is then moved to a retracted and safe position withdrawn from the path before the container has been fully removed from the housing 22. Thus, in illustrated apparatus 20, the blade 30 is at no time exposed supposed to the user.

FIG. 1 illustrates the CD container or case 26 about to be inserted into the cutting apparatus 20.

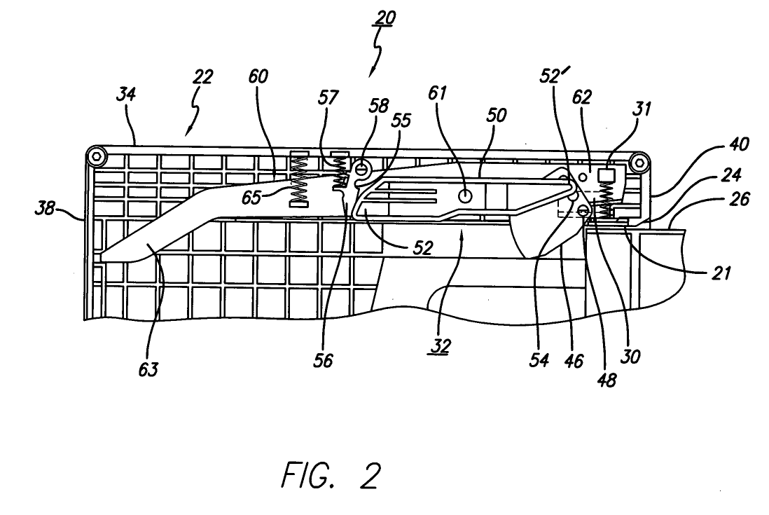

FIG. 2 illustrates the internal parts of the apparatus 20, including the cutting blade 30 and a blade controlling retraction mechanism 32 for extending and retracting the blade as the container 26 is inserted and then withdrawn from the receptacle 24 of the apparatus.

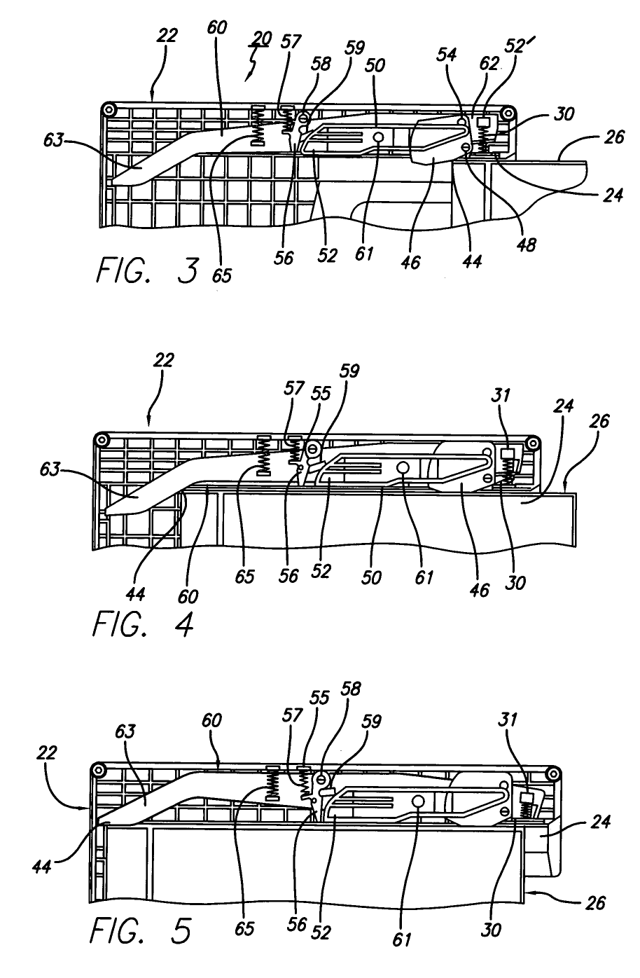

FIGS. 3 through 8 illustrate the sequence of operations as the container 26 is first inserted and then remove from the apparatus.

More particularly, the illustrated housing or frame 22 has a thin generally rectangular shape. The apparatus 20 is illustrated with the housing 22 being in an upright position, however, it may be utilized in other positions as desired. For convenience the apparatus 20 will described with the housing in such upright orientation. The illustrated housing 22 includes a pair of opposed large sidewalls 32, top and bottom walls 34,36, a rear wall 38, and a front wall portion 40 at the top of the housing.

In general terms, the housing 22 is provided with guides 21 that support and guide the container 26 along a predetermined path. In this regard, the housing 22 has an opening along the front edge (except for the front wall portion 40) to define an entrance/exit 42 to and from the interior of the housing. The housing 22 is form with horizontally extending upper and lower guides 21 that extend from the entrance 42 to the rear end of the housing. The large sides of the housing provide side guides 21. The upper, lower and side guides 21 define the predetermined path of the container into and out of the housing 22. The path is sized and proportioned to receive there along a standard thin, rectangular CD container or case 26 in a relatively close or snug fit that will maintain the position of the container while it is within the housing and will allow it to be inserted and remove from the housing. The major portion of the path within the housing 22 where the container resides when it is fully inserted into the housing is defined as the receptacle 24. The side walls 32 have cut-outs 33 to facilitate the container's insertion into and removal from the receptacle 24. The illustrated housing 22 is constructed of a pair of plastic molded halves that are secured to one another by standard means. The housing halves may be formed with a matrix of reinforcing ribs to provide desired rigidity while minimizing use of material.

FIG. 2 illustrates the apparatus 20 in its ready mode prior to the CD container 26 being inserted. It will be noted that the cutting blade 30 is in a retracted safe position where it cannot be accessed even when someone tries to put their finger inside the receptacle 24. The cutting blade 30 is mounted at the right end 62 of an elongated pivot bar assembly 60. The pivot bar assembly 60 is pivotally mounted and spring-loaded by a spring 65 in the retracted counterclockwise position.

Lowering of the blade 30 to the cutting position requires that the CD container engage and move two separate elements. The first such element is a latch actuator 46. The latch actuator 46 is pivotally mounted on a transverse pin 48 and biased counterclockwise to the lower downwardly extending position by a spring (not shown). When the latch actuator 46 is moved upwardly by the container, it shifts a latch release bar 50 to the right and out of contact with a spring-biased latch 56. This allows the latch 56 to subsequently lock the pivot bar assembly 60, and thus the blade, in the extended cutting position.

The second such element is a lever portion 63 at the left end of the pivot bar assembly 60. Movement of the lever portion 63 by the container rotates the pivot bar assembly 60 clockwise to lower the cutting blade 30 to its expose cutting position (see FIG. 5). The pivot bar assembly 60 is locked in the cutting position by a notch on the latch 56 receiving a projection 59 on the pivot bar subassembly 60 when the subassembly is moved to the cutting position. This maintains the cutting blade 30 in its lowered position to cut through the film layer 28 and the manufacturer's label ML along the upper edge of the CD container as the container is withdrawn from the receptacle 24 to the right. The cutter 30 is positioned relative to the CD container to accomplish the cut generally along line X-X as described above to facilitate effective opening of the container by the user.

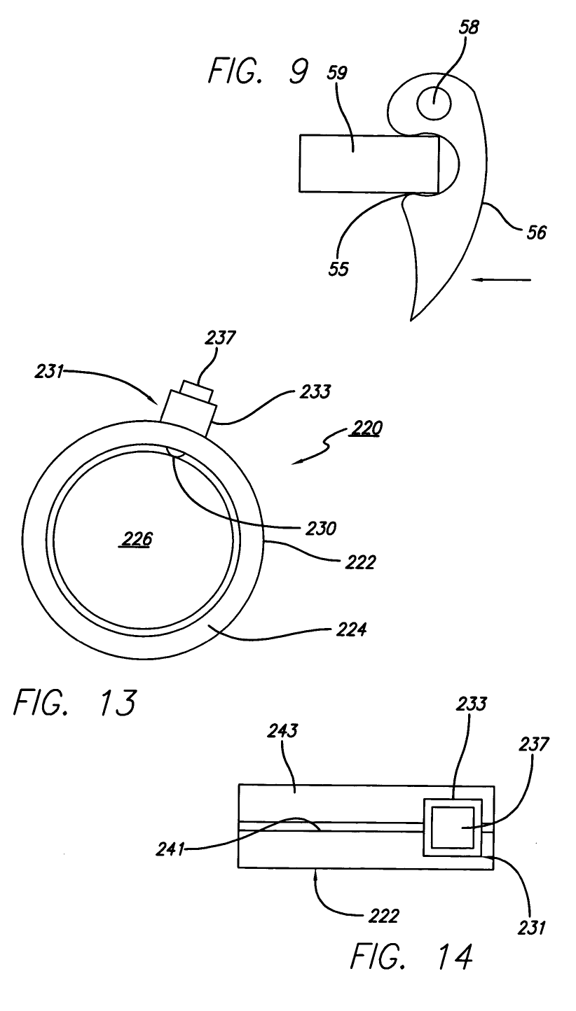

When the container 26 has been withdrawn sufficiently to allow the latch actuator 46 to return to its lowered position as shown in FIG. 9, the latch release bar 50 is slid to the left, the latch 56 is rotated clockwise to the left. This disengages notch of the the latch 56 from the projection 59 of the subassembly 60 and allows the biased subassembly to rotate counterclockwise to raise the cutting blade 30 out of the receptacle 24. Prior to this point, the CD container has been blocking the user from the area where the blade extends when it went into its extended lowered cutting position. Before the container is fully removed, the blade has been retracted and presents no danger to the user. The cutting apparatus is at that time again in its ready mode for receipt of the next container to be cut.

Now the apparatus 20 and its operation will be described in further detail.

As shown in FIG. 3, as the CD container or case 26 initially enters the receptacle 24 from the right and move along the path, the the upper forward edge 44 of the container first makes contact with the spring-biased lowered latch actuator 46 which is pivotally mounted in the housing on the pin 48. As the edge 44 advances, it causes the latch actuator 44 to raise up and pivot clockwise, which in turn moves a latch release bar 50 to the right. The latch release bar 50 is mounted within the housing for front-to-back sliding movement. The latch release bar 50 has a pin 52 at its right end that rides in a slot 54 on the latch actuator 44. The clockwise rotation of the latch actuator 44 acts through this pin and slot connection 52,54 to cause the latch release bar 50 to slide to the right.

This moves the left end 52 of the latch release bar 50 to the right. This allows space for the spring-biased latch 56 to later move to the right, to a position where a notch 55 on the latch will interlock with a projection 59 on the pivot bar subassembly 60 to hold the subassembly in the cutting position. At this time, however, the projection 59 is positioned below the notch 55 so that the projection 59 engages the edge of the latch 56 below the notch 55 to thereby retain the latch in the position shown in FIG. 3. FIG. 9 is a schematic illustration of the latch 56 showing the notch 55 and the projection 59 received within the notch.

The latch 56 is pivotally mounted at its upper end within the housing on a transverse pin 58 and extends generally downwardly. The latch 56 is biased by a spring 57 in the counterclockwise direction. The latch has the notch 55 for receiving the projection 59 on the pivot bar subassembly 60 when the subassembly later moves to the cutting position. The cutting blade 30 is carried at the right end 62 of the subassembly 60 adjacent to the entrance 42 to the receptacle 24. The blade 30 remains in the retracted position until the subassembly 60 is moved to the cutting position.

As shown in FIG. 4, as the CD container 26 continues to enter the receptacle 24, the upper forward edge 44 of the container next engages the lever 63 at the left end of the pivot bar subassembly 60. 61. The pivot bar subassembly 60 is basically an elongated, generally horizontally extending arm, pivotally mounted on a pin 61 intermediate its ends, with the cutter blade 30 mounted on the right end 62 near the entry 42 to the receptacle.

Further insertion of the CD case 26 causes the corner 44 to lift the lever 63 at the left end of the pivot bar subassembly 60. This pivots the subassembly 60 clockwise and causes the cutting blade 30 to the brought down to its cutting position so as to engage end cut through the thin covering film and the manufacturer's sealing label that extend along the upper edge of the CD container as the container moves to the fully inserted position shown in FIG. 5. It will be noted that the blade 30 is bi-directional, cutting with its right-facing edge as the container moves to the left.

As the container 26 fully enters the receptacle 24 as shown in FIG. 5, and the subassembly 60 rotates clockwise so that its left end rises, the latch 59 subassembly moves up the latch 56 and then enters and interlocks with the notch 55 on the latch. The subassembly 60 and the blade 30 are now locked in the cutting position. It will be noted that the container 26 occupies the receptacle 24 at this time, making it virtually impossible for a person's finger to reach the blade 22 which is now in its exposed cutting position.

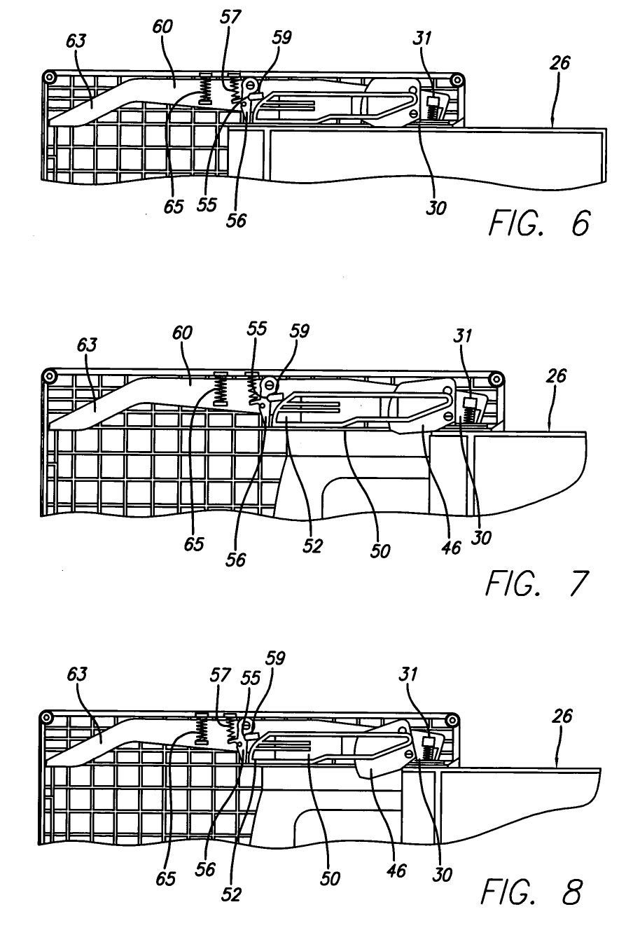

As shown in FIG. 6, the container 26 is being withdrawn to the right from the receptacle 24. As the container is thus removed, the cutting blade 30 is held in the lowered cutting position as it performs a cut of the film layer and label that extend across the top edge of the container. This cut is performed by the left-facing edge of the bi-directional blade 30.

As shown in FIG. 7, as the CD container 24 exits past the spring-loaded latch actuator 46, the latch actuator is thereby allowed to begin to descend. As the latch actuator 46 descends, it moves the latch release bar 50 to the left. The left end 52 of the latch release bar 50 in turn pushes the latch 56 to the left until the latch notch 55 disengages from the projection 59 on the subassembly 60. FIG. 8 shows the apparatus 20 just before the disengagement.

When the CD container 24 has been sufficiently withdrawn, the full release of the latch allows the pivot bar subassembly to return to the standby mode which is shown in FIG. 2, In this mode, the cutter blade is once again fully receded in its withdrawn position. This fully receded cutter blade position is achieved before the CD container is fully removed from the receptacle so that, by the time the container is fully removed, the blade is fully withdrawn and cannot be reached by a users' finger.

Now the cut plastic film 28 and the cut portions of the manufacturer's sealing label can be readily removed from the CD container, the container may be opened, and the CD may be removed for use.

The illustrated cutting blade 30 is pivotally mounted on the right end 62 pivot arm subassembly 60 and is spring-loaded by spring 31 so that you have access pressure is placed on the blade that will displace rather than causing harm.

FIGS. 10 through 12 illustrate a different cutting apparatus 120 which also comprises a presently preferred embodiment of the invention. Apparatus 120 incorporates a movable cutting blade 130.

This illustrated apparatus 120 includes a generally flat rectangular housing or frame 122 having a generally rectangular receptacle 124 for receipt therein of a CD case or container 26. The housing 122 is open at one side to provide an entrance to permit the CD container 26 to be inserted into the receptacle 124. A cover or door 123 may be provided to secure in place over the entrance to the receptacle to maintain the container in the receptacle during the cutting operation. The door may be pivotally mounted and provided with a latch, bar it may be attached by a snap-fit or the like. Thus, in this embodiment 120, the container is maintained stationary while the cutter 130 is moved.

A movable cutter blade 130 is provided at the top of the illustrated apparatus 120. The blade 130 is mounted on a carrier assembly 131 that is supported for sliding movement right-to-left and then back to right

The illustrated assembly 131 includes a generally rectangular housing 133 that houses a vertically reciprocal plunger 135. The plunger 135 carries the cutting blade 130 and its lower end and a pushbutton 137 and its upper end. The plunger is spring-loaded upwardly by a spring 139 which surrounds it and is enclosed within the housing 133. The plunger 135 extends through a slot 141 that extends a cross the top wall 143 of the housing 133.

To cut through the outer film layer 28 and the manufacturer's sealing label on a CD container using apparatus 120, the container is placed in the receptacle 124 and a cover 123 closed to securely hold a container in place. The cut or assembly 131 may be positioned fully right or left, the pushbutton 137 depressed to lower the cutting blade 130 into cutting position relative to the container within the receptacle 124, and, while the pushbutton is maintained depressed, slid across the full-length of the top wall 143 to effect the desired cut.

The pressure on the pushbutton 137 that may then be released to allow retraction of the cutter blade 130 clear of the container. Container 26 may then be removed from the receptacle 124 and the film and label readily removed from the container.

FIGS. 13 and 14 schematically illustrate another form of cutting apparatus 220 which is similar to the apparatus of FIGS. 10-12 except that the housing 222 is generally disk-shaped rather than rectangular to accommodate a generally disk-shaped container 226. A blade carrier assembly 231 includes a housing 233 and a pushbutton 237 for moving the cutting blade 230 into cutting position. A slot 241 extends along the peripheral wall 243 to serve as a guide for the cutting mechanism 231. The cutting assembly 231 is then moved a sufficient distance around the periphery of the container 26 to provide an adequate cut through the container outer layer and label. In this embodiment the blade moves along a non-linear path.

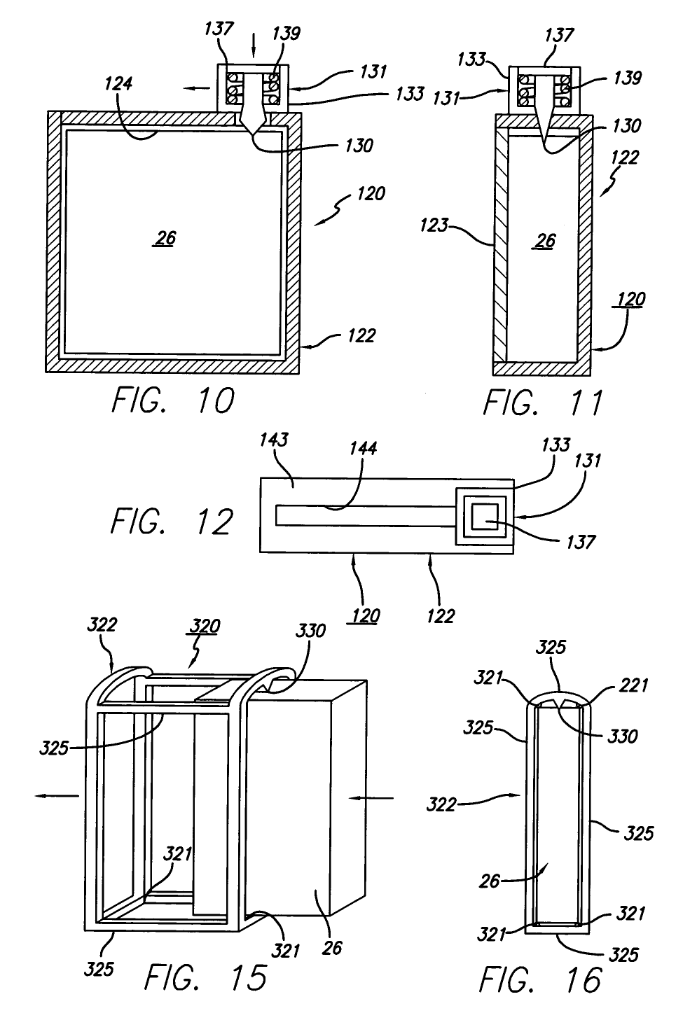

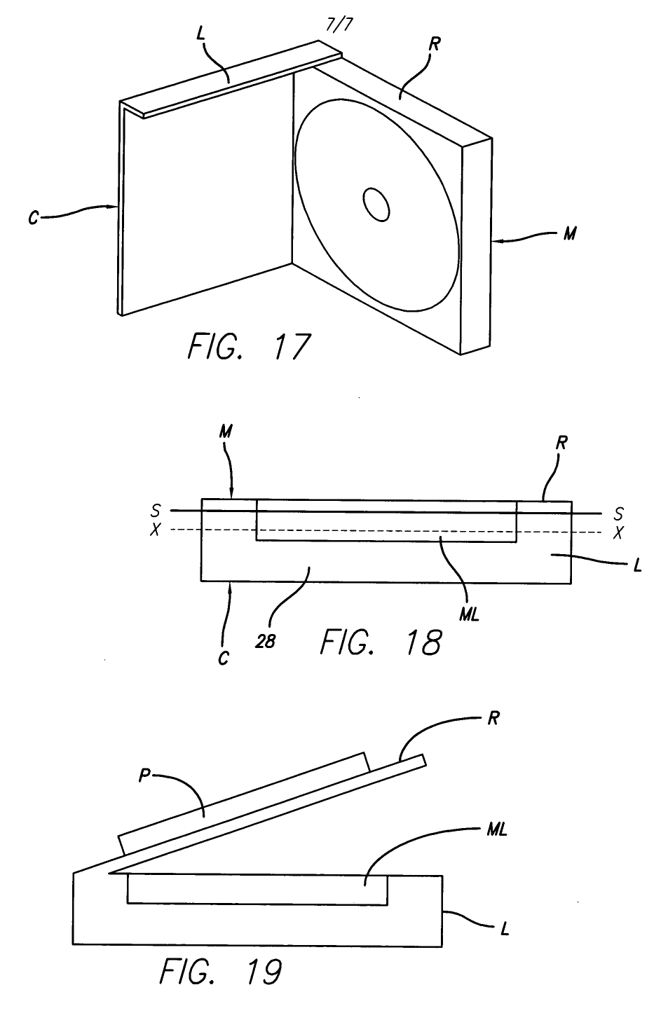

FIGS. 15 and 16 schematically illustrate a simple fixed location blade form of cutter apparatus 320 that is another presently preferred embodiment of the invention. The illustrated apparatus 320 includes an open frame 322 formed from elongated rod sections 325.

The frame 322 provides guides 321 that define a path for receiving a CD container 26. The illustrated path is open both at its front and rear (right and left) so that the container may be simply inserted at the right and withdrawn at the left. A fixed cutter blade 330 is mounted within the frame 322 and position so that it will engage and cut the film 28 and the label ML extending over the upper edge of the container as the container passes through the path. The film and label may then be readily removed from the container.

Various other modifications and changes may be made to the illustrated structures without departing from the spirit and scope of the invention as set forth claims.

1. Apparatus for cutting through an outer layer on a container, said apparatus comprising:
a frame for guiding the container along a predetermined path,
a cutting blade mounted on said frame in a fixed location along the path, and extending into the path so that, during at least a portion of the time that the container is moving along the path, said blade is positioned to engage and cut through the outer layer on the container.

2. The apparatus of claim 1 wherein the container is of the type used for holding CDs and DVDs and the outer layer includes the manufacturer's sealing label.

3. The apparatus of claim 2 wherein the container has a cover with a lip and a main body with a thin rib, the line of separation between the cover and the main body when the container is closed is between said lip and said rib, the cut through the label being sufficiently close to the line of separation to allow the container to be readily opened without damage after the cut has been made, and the cut through the label being sufficiently far from the line of separation so that a cut portion of the label adhered to the lip is sufficiently large to allow it to be grasp by the user to remove that portion from the main body.

4. The apparatus of claim 2 wherein the container has a cover and a main body and there is a line of separation between, the cut being spaced inwardly a short distance from the line of separation.

5. The apparatus of claim 4 wherein the cut is spaced from about 0.050 of an inch to about 0.14 of an inch from the line of separation.

6. The apparatus of claim 2 wherein the outer layer also includes a thin plastic outer wrapping film.

7. The apparatus of claim 1 wherein said frame is in the form of an enclosed housing which has a receptacle for receiving the container, said housing shielding said cutting blade from the user.

8. The apparatus of claim 7 further including a retraction mechanism that supports said cutting blade for movement between and a cutting position where the blade extends into the receptacle and a retracted safe position where the blade does not extend into the receptacle.

9. The apparatus of claim 8 wherein said retraction mechanism automatically moves said cutting blade from said retracted safe position to said extended cutting position after the container initially enters the receptacle and before the container has fully emerged from the receptacle, and moves said cutting blade back to said retracted safe position before set container has fully emerged from the receptacle.

10. The apparatus of claim 9 wherein said housing as a front and a back, said receptacle having an entrance at said front and an exit at said back.

11. The apparatus of claim for 9 wherein said housing has a front, said receptacle having a combination entrance and exit at said front, the container both entering and exiting the receptacle through said front combination entrance and exit.

12. The apparatus of claim 7 wherein said receptacle is thin and generally rectangular for receiving therein in a generally close fit a thin and generally rectangular container, said path being generally linear, said blade being positioned and said path extending so that said blade engages and cuts through a layer that extends along one straight edge of said rectangular container.

13. The apparatus of claim 8 wherein at least two separate elements of said retraction mechanism must be moved before the cutting blade will move to the cutting position.

14. The apparatus of claim 9 wherein said retraction mechanism is automatically operated by movement of the container into and/or out of said receptacle.

15. Apparatus for cutting through an outer layer on a container, said apparatus comprising:
a housing having an internal receptacle for removably receiving the container, said receptacle having an opening for providing access thereto, said housing including guides within said receptacle for guiding the container along a predetermined path initially into and then out of said receptacle,
a cutting blade mounted in said housing in a fixed location along the path,
a blade controlling mechanism for controlling movement of the cutting blade between a retracted position where the blade is withdrawn from the receptacle and a cutting position where the blade extends into the receptacle in position to engage and cut through the outer layer on the container as the container moves along the path,
said mechanism being operable to (i)initially maintained said blade in the withdrawn position,(ii) move said blade to the cutting position and to lock said blade in that cutting position while the container is moved along the path, and (iii) return the blade to the withdrawn position when the container is removed from the receptacle.

16. The apparatus of claim 15 wherein said blade control mechanism is automatically operated by the movement of the container along the path into the receptacle and/or out of the receptacle.

17. The apparatus of claim 16 wherein said blade control mechanism is automatically operated by the movement of the container along the path to(i) initially moved the blade to the cutting position only after the container has begun to enter the receptacle,(ii) lock the blade in the cutting position as the container continues to enter the receptacle and as it is withdrawn from the receptacle, and (iii) unlock the blade and return it to the withdrawn position only after substantially all of the container has exited the receptacle.

18. A method for cutting through an outer layer on a container, said method comprising the steps of:
guiding the container along a predetermined path,
positioning a cutting blade in a fixed location along the path, and extending into the path so that, during at least a portion of the time that the container is being guided along the path, the blade is positioned to engage and cut through the outer layer on the container.

19. The method of claim 18 wherein the container is of the type used for holding CDs and DVDs and the outer layer includes the manufacturer's sealing label.

20. The method of claim 19 wherein the container has a cover with a lip and a main body with a thin rib, the line of separation between the cover and the main body when the container is closed being between said lip and said rib,
positioning the cutting blade so that the cut is through the label(i) sufficiently close to the line of separation to allow the container to be readily opened without damage after the cut has been made, and (ii) sufficiently far from the line of separation so that a cut portion of the label adhered to the lip is sufficiently large to allow it to be grasp by the user to remove that portion from the main body.

21. The method of claim 19 wherein the container has a cover and a main body, and there is a line of separation between the cover and the main body, positioning the cutting blade so that the cut spaced inwardly a short distance from the line of separation.

22. The method of claim 21 wherein the cutting blade is spaced from about 0.050 of an inch to about 0.14 of an inch from the line of separation.

23. The method of claim 18 wherein the cutting blade is moved from a retracted safe position where the blade does not extend into the path to a cutting position after the container initially enters the path and before the container has fully emerged from the path, and the blade is moved back to the retracted safe position before the container has fully emerged from the path.

24. The method of claim 18 where the movement of the cutting blade is automatic in response to the movement of the container along the path.

25. The method of claim 18 wherein the container enters one end of the path and emerges from the opposite end of the path.

26. The method of claim 18 wherein the container both enters and exits from the same end of the path.

27. A method for cutting through an outer layer on one straight edge of a thin generally rectangular container for a CD or the like, said method comprising the steps of:
holding the container in a fixed position,
moving a cutting blade generally linearly relative to such container edge so that the blade will engage and cut through the outer layer on the edge incident to such movement of the blade.

28. The method of claim 27 wherein the outer layer includes the manufacturer's sealing label.

29. The method of claim 28 wherein the container has a cover with a lip and a main body with a thin rib, the line of separation between the cover and the main body when the container is closed being between said lip and said rib,
positioning the cutting blade so that the cut is through the label(i) sufficiently close to the line of separation to allow the container to be readily opened without damage after the cut has been made, and (ii) sufficiently far from the line of separation so that a cut portion of the label adhered to the lip is sufficiently large to allow it to be grasp by the user to remove that portion from the main body.

30. The method of claim 28 wherein the container has a cover and a main body, and there is a line of separation between the cover and the main body, positioning the cutting blade so that the cut spaced inwardly a short distance from the line of separation.

31. The method of claim 30 wherein the cutting blade is spaced from about 0.050 of an inch to about 0.14 of an inch from the line of separation.

32. The method of claim 27 further including the step of maintaining the cutting blade in a retracted position wherein it is shielded from the user when the blade is not being moved relative to the container.

33. The method of claim 32 wherein the cutting blade is selectively movable between (1) the retracted shielded position where such linear movement of the blade will not cause it to engage the layer, and (2) a cutting position where such a linear movement of the blade will cause it to engage the cover.

34. Apparatus for cutting through an outer layer on a container, said apparatus comprising:
a frame for removably holding the container in a fixed position,
a carrier on said frame for holding a cutting blade,
said carrier being positioned and movable relative to the container being held by the frame so that the blade will engage and cut through the outer layer on the container incident to such movement of the blade.

35. The apparatus of claim 34 wherein the container is of the type used for holding CDs and DVDs and the outer layer includes the manufacturer's sealing label.

36. The apparatus of claim 35 wherein the container has a cover with a lip and a main body with a thin rib, the line of separation between the cover and the main body when the container is closed is between said lip and said rib, the cut through the label being sufficiently close to the line of separation to allow the container to be readily opened without damage after the cut has been made, and the cut through the label being sufficiently far from the line of separation so that a cut portion of the label adhered to the lip is sufficiently large to allow it to be grasp by the user to remove that portion from the main body.

37. The apparatus of claim 35 wherein the container has a cover and a main body and there is a line of separation between, the cut being spaced inwardly a short distance from the line of separation.

38. The apparatus of claim 37 wherein the cut is spaced from about 0.050 of an inch to about 0.14 of an inch from the line of separation.

39. The apparatus of claim 34 wherein said frame is in the form of an enclose housing that includes a receptacle sized and configured to receive and hold the container in the fixed position, said blade being positioned within said housing, said receptacle having at least one opening to permit insertion of the container into the receptacle and removal of the container from the receptacle.

40. The apparatus of claim 39 wherein said housing includes locking means for retaining the container in said receptacle in the fixed position.

41. The apparatus of claim 39 wherein said housing has a thin generally rectangular receptacle for receiving a thin generally rectangular container for a CD or the like, said carrier for said cutting blade supporting said blade within said housing, said carrier and blade being movable along one edge of said rectangular receptacle so that said blade engages and cuts through the outer layer extending over the adjacent edge of the rectangular container.

42. The apparatus of claim 39 wherein said housing has a thin receptacle for receiving therein a thin container having a nonlinear edge, said carrier for said cutting blade supporting said blade within said housing, said carrier and blade being movable along said nonlinear edge of said receptacle so that said blade engages and cuts through the outer layer extending over that edge.

43. The apparatus of claim 39 wherein said cutting blade is selectively movable between a retracted safe position not extending into said receptacle and a cutting position extending into said receptacle, said cutting blade also being movable relative to the container which is being held in the fixed position in said receptacle so that, when said blade is in said extended cutting position, such movement of said blade relative to the container will cause said blade to engage and cut through the outer layer extending over the adjacent portion of the container.
